(19) United States
(12) Patent Application Publication
(10) Pub. No.: US 2017/0224164 A1
(43) Pub. Date: Aug. 10, 2017

(54) DEVICE FOR GRINDING AND DOSING COFFEE

(71) Applicant: Hausbrandt Trieste 1892 SPA, Nervesa della Battaglia (TV) (IT)

(72) Inventor: Martino ZANETTI, Treviso (IT)

(21) Appl. No.: 15/121,413

(22) PCT Filed: Feb. 27, 2015
(86) PCT No.: PCT/IB2015/051466

§ 371 Date: Aug. 25, 2016

(30) Foreign Application Priority Data
Mar. 4, 2014 (IT) TV2014A000031

(51) Int. Cl. A47J 42/06; A47J 42/40; A47J 42/44; B02C 23/02; B02C 25/00

(52) U.S. Cl. CPC A47J 42/06; B02C 23/02; B02C 25/00; A47J 42/44; A47J 42/40

(57) ABSTRACT

A coffer grinding and dosing device (12) comprises: a collection chamber (16) for containing coffee beans, underneath which a grinding zone (14) comprising a grinder (18) operated by an electric motor (20) is provided. The device is characterized in that the collection chamber (16) is positioned underneath the electric motor (20).

The present invention relates to a coffee grinding and dosing device.

In the prior art there exist numerous types of devices for grinding roasted coffee beans and for supplying a dosed amount of the powder obtained from grinding into the cavity of a filter-holder.

The grinding and dosing devices comprise a hopper inside which the roasted coffee beans are introduced before being ground. The hopper is provided with a lid, usually at the top, which closes the opening for loading the coffee beans.

The preparation of a large amount of coffee involves the continuous filling of the hopper, which must therefore be an operation which is easy to perform so that the user, typically a person working in a bar, takes as little time as possible in order to complete the operation.

Below the hopper there is the actual grinding zone into which the beans fall by means of gravity.

The grinding zone comprises a grinder operated by an electric motor. The grinding operation, which is performed in dry conditions, may be performed by means of impact or friction.

Grinding by means of impact is performed with a series of blades which are rotated at high speed and which repeatedly strike the coffee beans, reducing them into powder form.

Grinding by means of friction is performed by causing the coffee beans to pass between two grinders moving relative to each other. The grinders have a geometrical configuration such that the space between the two grinders gradually decreases as the beans are first trapped between the two grinders and then pulverized.

The grinders may be of various types, for example:
cylindrical grinders, in which two cylinders with parallel axes rotate in opposite directions;
flat grinders, in which a pair of discs are housed inside a frustoconical cavity (the discs are positioned above each other so that their bases nearly touch each other); and
conical grinders, in which a conical element rotates inside a frusto-conical cavity.

The grinders are operated by an electric motor which is usually powered from the mains and is contained inside the grinding and dosing device. The electric motor is usually situated between the storage container and the grinding zone, or underneath the grinding zone.

Once the coffee beans pass through the grinding zone, they are reduced into the form of a powder which is then conveyed to a collector. The bottom of the collector is provided with the dosing device which may consist of a shutter which can be opened and closed, upon command, so as to supply powder to an underlying filter-holder.

The collector is a small storage container inside which the ground coffee is collected before being fed into the filter-holder cavity. The small storage container may also comprise movable flaps for facilitating the descent of the ground coffee.

Also known in the prior art are other embodiments in which no storage container for accumulating the ground coffee is provided, but the coffee is produced at the moment of use in the amount required to fill the filter-holder.

The devices of the known type are also provided with a conveyor for ensuring that the coffee powder falls precisely into the filter-holder cavity and not outside of it.

The prior art, although widely used, is not without drawbacks.

Firstly the positioning of the electric motor for operation of the grinders underneath the hopper results in considerable heating of the structure of the device and the coffee beans which are situated inside the hopper above it.

Prolonged heating of the roasted coffee beans could cause the deterioration of their organoleptic properties, thus negatively affecting the quality and the appearance of the beverage.

In the case of a dosing device without storage container, where the product is conveyed into a collector or a chute, the ground coffee powder could adhere to the walls resulting in the product becoming stale and the formation of a mechanical obstruction.

The object of the present invention is therefore to solve the drawbacks of the prior art.

A first task of the present invention is to provide a coffee grinding and dosing device in which the roasted coffee beans are protected from heating due to the grinder operating motor.

Moreover, a second task of the present invention is to provide a device in which there are no zones where the coffee powder may accumulate, so as to avoid the risk of staleness and alteration of the organoleptic properties.

The abovementioned object and tasks are achieved with a coffee grinding and dosing device according to claim 1.

The idea which has occurred is to provide a coffee grinding and dosing device comprising a collection chamber for containing the coffee beans, underneath which a grinding zone is provided. The grinding zone comprises a grinder operated by a motor, for example of the electric type. The device according to the present invention is characterized in that the collection chamber is positioned underneath the motor, in the falling direction of the coffee powder.

The characteristic features and advantages of a coffee grinding and dosing device according to the present invention will emerge more clearly from the description, provided hereinbelow, of a number of examples of embodiment provided by way of a non-limiting illustration, with reference to the attached drawings, in which:

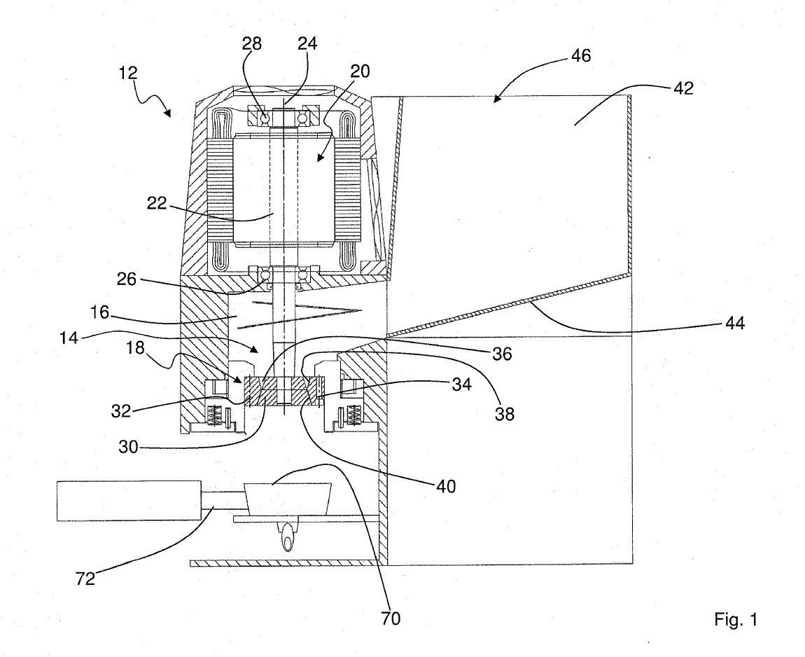

FIG. 1 shows a side view in schematic form of a coffee grinding and dosing device according to the present invention;

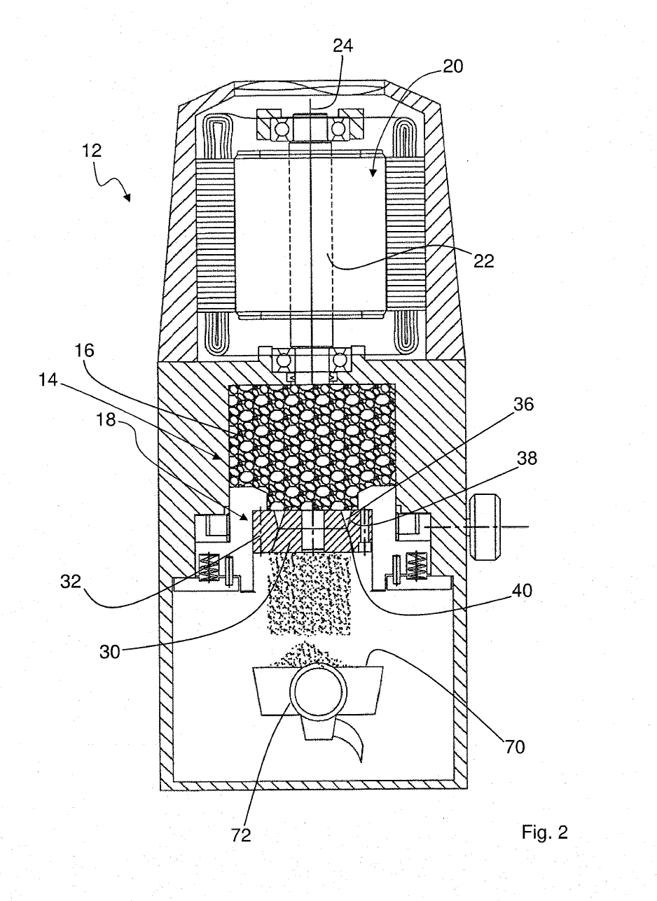

FIG. 2 shows a front view of the device according to FIG. 1 inside which the coffee beans and the coffee powder are schematically shown; and

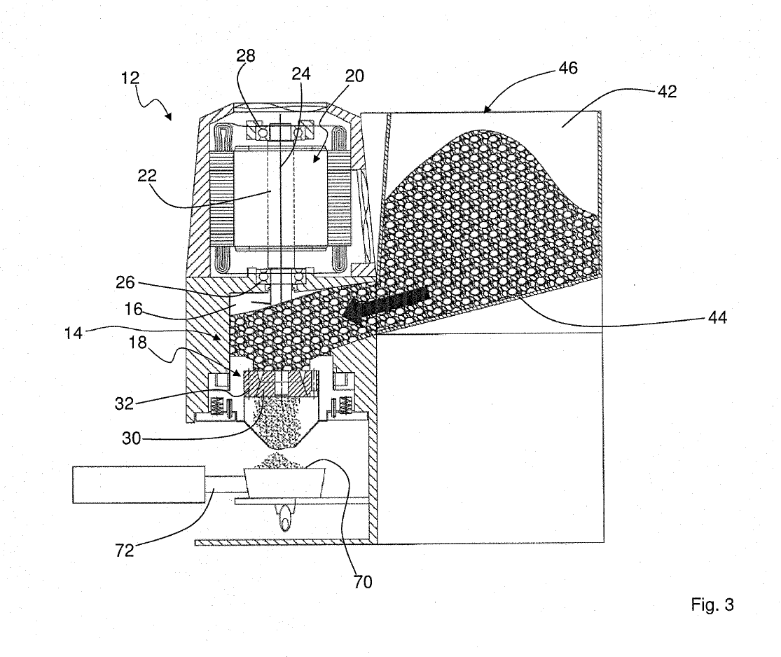

FIG. 3 shows the coffee grinding and dosing device according to FIG. 1, in which the coffee beans and the coffee powder are schematically shown.

FIG. 1 shows a coffee grinding and dosing device according to the present invention, which is denoted generally by the reference number 12.

Inside the grinding and dosing device according to the present invention it is possible to define a grinding zone—denoted by the reference number 14 in the figures—which comprises a collection chamber 16 for the coffee beans and a grinder 18 operated by an electric motor 20.

The electric motor 20 is of the type known per se which can be easily imagined by the person skilled in the art and may be powered by means of the electricity mains and/or by means of batteries, for example of the rechargeable type.

As can be clearly seen in FIG. 1, the electric motor 20 is provided with an output shaft 22 which during operation rotates about its axis 24, which will also be referred to as the axis of the electric motor 20. The output shaft 22 is designed to move the grinder 18, as will be described below.

In accordance with a possible embodiment of the present invention which can be seen in FIG. 2, the electric motor 20 may be positioned above the collection chamber 16. The collection chamber 16 is in turn positioned above the grinder 18. In other words, the grinder 18, the collection chamber 16 and the electric motor 20 are positioned above one another in the direction of the axis 24 of the electric motor, so that the grinder 18 is the element closest to the zone where the powder is discharged.

Advantageously, the electric motor 20 may be axially aligned with the axis of rotation of the grinder 18. In this case, the output shaft 22 of the electric motor 20 passes inside the collection chamber 16. Preferably, the output shaft 22 is isolated from the internal part of the collection chamber 16 and may be enclosed inside a duct (not shown). In this way the coffee beans contained inside the collection chamber 16 do not come into contact with the output shaft 22.

In accordance with a possible embodiment of the present invention (not shown in the attached figures) the output shaft 22 may not be in axial alignment with the axis of rotation of the grinder 18. Advantageously, a mechanical transmission may be provided, such as a gearing comprising two gearwheels, by means of which the rotational movement is transmitted to a second shaft in axial alignment with the axis of rotation of the grinder 18.

Bearings 26, 28, suitably spaced from each other, may be provided for rotation of the output shaft 24, as can be clearly seen for example in FIG. 1.

The grinder 18 may be of the known type, for example a conical grinder in which a movable part 30 has an overturned frustoconical form and is designed to rotate inside a fixed part 32. The output shaft 24 is connected directly or via other means to the movable part 30 of the grinder 18.

As can be clearly seen in the embodiment shown in FIG. 1, the fixed part 32 may be fixed to the bottom end of the collection chamber 16, for example by means of screws (the figures do not show screws, but a seat 34 for the at least one of the screws used for fixing). The fixed part 32 has a through-hole 36 inside which the movable part 30 is inserted. Considering the direction in which the ground coffee powder falls through the grinder 18, the through-hole 36 may have a first converging section (indicated by 38 in the figures) and a second diverging section (indicated by 40 in the figures). As can be clearly seen in the figures, the space between the movable part 30 and the converging hole part 38 decreases in the falling direction of the powder, so that firstly the coffee beans remain trapped between the side walls of the two parts and then they are pulverized with dimensions equal to the increasingly more confined space inside which they are situated. Along the diverging section 40, the space situated between the movable part 30 and diverging section 40 decreases again, thereby reducing the coffee powder to the desired size.

As mentioned above, a collection chamber 16 is provided between the electric motor 20 and the grinder 18 and may be advantageously fed by a hopper 42.

The hopper 42 is designed to hold the coffee beans before they reach the collection chamber 16, as can be clearly seen in FIG. 3. The hopper 42 comprises an opening 46 for loading the coffee beans. Advantageously, the opening 46 may be provided on the top part of the hopper 42 and may be provided with a lid (not shown).

Preferably, the hopper 42 is provided with a bottom wall 44 which is inclined downwards and designed to cause the coffee beans to slide towards the collection chamber 16 situated between the electric motor 20 and the grinder 18.

In accordance with a possible alternative embodiment, not shown in the attached figures, the hopper 42 may coincide with the collection chamber 16 which may therefore may be provided with a lateral opening for loading the coffee beans.

The hopper may be made of transparent material so that the user may see the amount of coffee beans contained inside it.

The relative positioning of the hopper 42, collection chamber 16 and electric motor 20 will now be described in detail.

In the coffee grinding and dosing device according to the present invention, the collection chamber 16 is positioned underneath the electric motor 20. Advantageously the collection chamber 16 may be positioned along the falling direction of the coffee powder, underneath the electric motor 20.

In accordance with a possible embodiment of the present invention, the hopper 42 is positioned laterally with respect to the electric motor 20. In other words, the hopper 42 may be offset laterally with respect to the axis 24 of the electric motor 20. Advantageously, the hopper 42 may be positioned alongside the electric motor 20.

In a further embodiment, also not shown in the accompanying figures, the electric motor 20 may be axially offset with respect to the grinder 18. Advantageously, the hopper 42 may be located above the grinder 18, and the motor 20 laterally with respect to the hopper 42. In this case, the output shaft 22 of the electric motor 20 is not axially aligned with the grinder 18. A shaft may therefore be provided, parallel to and spaced from the drive shaft 22, connected to the movable part of the grinder 18, and kinematically connected to the drive shaft 22.

In accordance with a possible embodiment of the present invention, heat insulating means (not shown) may be provided in order to insulate thermally the hopper 42 from the electric motor 20. Advantageously, said heat insulating means may consist of materials known per se to the person skilled in the art.

In accordance with a possible embodiment of the present invention, a control unit (not shown in the attached figures) may be provided for controlling operation of the electric motor and dosing of the coffee powder.

Advantageously, the control unit may be provided with a command device (also not shown) for operating the electric motor and therefore the grinder.

In accordance with a possible embodiment of the present invention, the control unit is programmable so as to set a grinder operating time for the production of a predetermined amount of coffee powder.

Advantageously, the freshly ground coffee powder is discharged directly into cavity 70 of a filter-holder 72.

The advantages of the coffee grinding and dosing device according to the present invention are therefore evident.

Firstly, by displacing the motor to the top part of the coffee grinding and dosing device the problems associated with overheating thereof are eliminated.

Advantageously, by placing the coffee bean loading container in the rear part of the machine, in a position isolated from the motor itself, overheating of the coffee beans is avoided.

Moreover, the dispensing of the ground coffee directly into the filter-holder cavity eliminates completely barriers, chutes or collecting flaps which are present in the conventional grinding and dosing devices, eliminating the stress due to contact affecting the ground coffee and overheating in addition to that which occurs inside the grinders, by using conical grinders which convey directly by means gravity the product into the filter, avoiding intermediate passages.

The person skilled in the art, in order to satisfy specific requirements, may make modifications to the embodiments described above and/or replace the parts described with equivalent parts, without thereby departing from the scope of the accompanying claims.

1. Coffer grinding and dosing device (12) comprising:
a collection chamber (16) designed to contain coffee beans, underneath which a grinding zone (14) is provided;
said grinding zone (14) comprises a grinder (18) operated by a motor (20);
characterized in that:
said collection chamber (16) is positioned underneath the motor (20).

2. Coffee grinding and dosing device (12) according to claim 1, characterized in that it comprises a hopper (42) designed to supply the collection chamber (16) with coffee beans.

3. Coffee grinding and dosing device (12) according to any one of the preceding claims, characterized in that the electric motor (20) is provided with an output shaft (22) connected to the movable part of the grinder (18).

4. Coffee grinding and dosing device (12) according to claim 3, characterized in that the output shaft (22) of the electric motor (20) passes inside the collection chamber (16).

5. Coffee grinding and dosing device (12) according to claim 4, characterized in that the output shaft (22) passes inside a duct and is isolated from the inside of the collection chamber (16).

6. Coffee grinding and dosing device (12) according to any one of the preceding claims, characterized in that the grinder (18) is a conical grinder provided with a movable part (30) having an overturned frustoconical form designed to rotate inside a fixed part (32).

7. Coffee grinding and dosing device (12) according to claim 2, characterized in that the hopper (42) is positioned laterally with respect to the electric motor (20).

8. Coffee grinding and dosing device (12) according to any one of the preceding claims, characterized in that it comprises a control unit designed to control operation of the motor.

9. Coffee grinding and dosing device (12) according to any one of the preceding claims, characterized in that it comprises a control unit designed to control dosing of the coffee powder.

10. Coffee grinding and dosing device (12) according to the preceding claim, characterized in that the control unit is programmable so as to set a grinder operating time for the production of a predetermined amount of coffee powder.

11. Coffee grinding and dosing device (12) according to any one of the preceding claims, characterized in that the grinder is designed to dispense coffee directly into the cavity of a filter-holder.
